(19) United States
(12) Patent Application Publication
(10) Pub. No.: US 2024/0073785 A1
(43) Pub. Date: Feb. 29, 2024

(54) METHOD AND APPARATUS FOR CONTROLLING DISASTER ROAMING SERVICE IN WIRELESS NETWORK

(71) Applicant: Samsung Electronics Co., Ltd., Gyeonggi-do (KR)

(72) Inventors: Samiran BHOWMIK, Bangalore (IN); Aman AGARWAL, Bangalore (IN); Kailash Kumar JHA, Bangalore (IN); Lalith KUMAR, Bangalore (IN); Erik GUTTMAN, Middlesex (GB); Mahmoud WATFA, Middlesex (GB)

(21) Appl. No.: 18/260,409

(22) PCT Filed: Jan. 5, 2022
(86) PCT No.: PCT/KR2022/000151

§ 371 Date: Jul. 5, 2023

(30) Foreign Application Priority Data
Jan. 5, 2021 (IN) 202141000356
Jan. 5, 2021 (IN) 202142059666
Jan. 13, 2021 (IN) 202141001704
Dec. 21, 2021 (IN) 202141000356

(51) Int. Cl. H04W 48/04; H04W 8/06; H04W 48/18

(52) U.S. Cl. CPC H04W 48/04; H04W 8/06; H04W 48/18; H04W 84/042

(57) ABSTRACT

The present disclosure relates to a communication method and system for converging a 5G communication system for supporting higher data rates beyond a 4G system with a technology for IoT. Embodiments herein provide method for controlling disaster roaming service in a wireless network by UE. The method includes receiving a disaster roaming enabled indication from first PLMN or second PLMN associated with UE. Further, the method includes detecting a disaster condition. Further, the method includes determining whether the disaster roaming enabled indication indicates that a disaster roaming is disabled in UE or disaster roaming is enabled in UE. In an embodiment, the method includes enabling the disaster roaming service at UE and allowing UE to select the PLMN for using the disaster roaming service during the disaster condition in response to determining that disaster roaming is enabled in UE.

### TECHNICAL FIELD

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

### BACKGROUND ART

Normally UEs receive service from Home PLMN(HPLMN) also commonly called as home operator or from the roaming PLMN(VPLMN) with which the home operator is having the agreement. This UEs enjoy service only if the HPLMN or the VPLMN is available in the area. If none of the HPLMN or VPLMNs are available in the area then UE end up being in the NO service state. There are other set of PLMNs called as forbidden PLMN(s) which have no agreement with HPLMN. Thus they do not provide any service to the UE. If forbidden PLMN(FPLMN) is available and no HPLMN or VPLMN is available then UEs will be in limited service state only to receive emergency services based on local regulation of the country.

Consider a case when there is a disaster occurs for e.g. due to earth quake/fire or any other reasons HPLMN or VPLMN network is impacted. Under such situations FPLMN can provide this disaster roaming service. However the challenge for HPLMN is that this services are going to be very costly because HPLMN do not take roaming agreement during normal situation and only in extreme case FPLMN is requested to pitch in. FPLMN would like to charge heavily during such situations taking advantage of the situation of the HPLMN not being able to serve its subscribers. HPLMN having no choice due to disaster in the network will have to agree on the set conditions of the FPLMN. Thus under such situations its important for HPLMN to have a better control of its UEs in order to determine if they have to receive disaster roaming service. If few UEs use the disaster roaming service then charges on HPLMN can be reduced but at the same time HPLMN may like to serve the UEs with the help of FPLMN to see that there is a minimize interruption of service.

Thus, it is desired to address the above mentioned disadvantages or other shortcomings or at least provide a useful alternative.

### DISCLOSURE OF INVENTION

### Solution to Problem

The principal object of the embodiments herein is to provide a method, a UE, and a PLMN for controlling a disaster roaming service. The proposed method can be used to improve HPLMN control on the UEs to receive the disaster roaming service.

Another object of the embodiments herein is to provide a method and the UE to indicate start and end of the disaster roaming service.

Another object of the embodiments herein is to provide the UE that is configured with a flag from a Home PLMN (HPLMN) or an Equivalent HPLMN (EHPLMN) using a NAS signaling. If the flag indicates that the UE is allowed to use disaster roaming, during disaster situation, the UE selects a PLMN providing disaster roaming service and receives the disaster roaming service. If the flag indicates that the UE is not allowed to use disaster roaming, then the UE remains in a limited service during the disaster situation.

Another object of the embodiments herein is to provide the UE configured with the disaster PLMN list. The disaster PLMN list can be pre-configured in the UE or updated by a home network or a serving network. The disaster PLMN list is in priority order which helps the UE to determine which the priority PLMN UE should camp and receive the disaster roaming service when HPLMN or VPLMN has faced the disaster situation.

Accordingly, the embodiment herein is to provide a method for controlling disaster roaming service in a wireless network. The method includes receiving, by a UE, a disaster roaming enabled indication from a first PLMN associated with the UE. Further, the method includes detecting, by the UE, a disaster condition. Further, the method includes determining, by the UE, whether the disaster roaming enabled indication indicates that a disaster roaming is disabled in the UE or disaster roaming is enabled in the UE. In an embodiment, the method includes enabling the disaster roaming service at the UE and allowing the UE to select a PLMN for using the disaster roaming service during the disaster condition in response to determining that disaster roaming is enabled in the UE. In another embodiment, the method includes disabling the disaster roaming service at the UE, not allowing the UE to select a second PLMN to receive the disaster roaming service, and entering a limited service state during the disaster condition, in response to determining that the disaster roaming is disabled in the UE.

In an embodiment, the disaster roaming enabled indication indicates that the disaster roaming is disabled in the UE due to one of: the UE is not configured with a disaster roaming enabled indication or when the disaster roaming enabled indication is configured and indicates disaster roaming is disabled in the UE.

In an embodiment, the disaster roaming enabled indication indicates that the disaster roaming is enabled in the UE if the UE is configured with the disaster roaming enabled indication and indicates the disaster roaming is enabled in the UE.

In an embodiment, the method includes storing, by the UE, the disaster roaming enabled indication in a Universal Subscriber Identity Module (USIM) of the UE or in the Mobile equipment(ME) of the UE.

In an embodiment, selecting the PLMN to receive the disaster roaming service comprise selecting a Forbidden PLMN (FPLMN) and registering with the FPLMN to receive the disaster roaming service services from the wireless network.

In an embodiment, detecting, by the UE, the disaster condition includes detecting, by the UE, whether the disaster roaming service from an allowable PLMN is available in the wireless network to receive normal services, and detecting, by the UE, the disaster condition when the service from the allowable PLMN is not available in the wireless network to receive the normal services and at least one FPLMN indicates the disaster roaming service is provided.

In an embodiment, Allowable PLMN is a PLMN which is not in the list of “forbidden PLMNs” (FPLMNs)

Accordingly, the embodiment herein is to provide a UE for controlling disaster roaming service in a wireless network. The UE includes a disaster roaming service controller connected to a memory and a processor. The disaster roaming service controller is configured to receive a disaster roaming enabled indication from a first PLMN associated with the UE. Further, the disaster roaming service controller is configured to detect a disaster condition and determine whether the disaster roaming enabled indication indicates that a disaster roaming is disabled in the UE or disaster roaming is enabled in the UE. In an embodiment, further, the disaster roaming service controller is configured to enable the disaster roaming service at the UE and allow the UE to select a second PLMN for using the disaster roaming service during the disaster condition in response to determining that disaster roaming is enabled in the UE. In another embodiment, further, the disaster roaming service controller is configured to disable the disaster roaming service at the UE, not allowing the UE to select a second PLMN to receive the disaster roaming service, and enter a limited service state during the disaster condition, in response to determining that the disaster roaming is disabled in the UE.

Accordingly, the embodiment herein is to provide a method for indicating start and end of disaster roaming service in a wireless network. The method includes detecting, by a UE, a disaster condition on a first PLMN to trigger registration for the disaster roaming service on a second PLMN. Further, the method includes triggering, by the UE, registration for the disaster roaming service by sending a flag to the second PLMN. Further, the method includes camping, by the UE, on the second PLMN for the disaster roaming service during the disaster condition. Further, the method includes receiving, by the UE, a non-access stratum (NAS) message from the second PLMN. The NAS message includes a cause #11(“PLMN not allowed”) indicating to the UE that the disaster condition has ended. Further, the method includes triggering, by the UE, a PLMN selection procedure to camp on the first PLMN.

In an embodiment, detecting, by the UE, the disaster condition comprises of: detecting, by the UE, no other PLMN is available to provide normal services to the UE, except for PLMNs in the UE's forbidden PLMNs list, detecting, by the UE, a PLMN without the disaster condition is able to accept disaster inbound roamers from the first PLMN with the disaster condition, detecting, by the UE, the indication of whether disaster roaming is enabled in the UE is set to “Disaster roaming is enabled in the UE, and detecting, by the UE, that first PLMN is not part of forbidden PLMN (FPLMN) lists.

In an embodiment, the UE does not receive the normal services over both 3GPP access and non-3GPP access.

In an embodiment, the flag is sent in a NAS registration request message with a registration type value “Disaster Roaming”.

In an embodiment, triggering, by the UE, a PLMN selection procedure includes receiving, by the UE, a NAS signalling connection release from the second PLMN, releasing, by the UE, a NAS signalling connection with the second PLMN after receiving the NAS signalling connection release from the second PLMN, adding, by the UE, the second PLMN in the FPLMN list, and performing, by the UE, the PLMN selection procedure.

In an embodiment, the method includes starting, by the UE, a timer to wait for the NAS signalling connection release from the second PLMN. Further, the method includes determining, by the UE, whether the timer is expired. Further, the method includes releasing the UE locally the NAS signalling connection with the second PLMN in response to determining that the timer is expired.

In an embodiment, the first PLMN (e.g., HPLMN or EHPLMN or VPLMN) is associated with a first service provider, and the second PLMN is FPLMN and is associated with a second service provider and is available in a disaster area of the first PLMN.

Accordingly, the embodiment herein is to provide a method for indicating start and end of disaster roaming service by a UE. The method includes receiving, by a second PLMN, a flag from the UE for registration to the disaster roaming service during a disaster situation with a first PLMN associated with the UE. Further, the method includes sending, by the second PLMN, a response allowing the UE to use the disaster roaming service during the disaster situation with the first PLMN. Further, the method includes detecting, by the second PLMN that the disaster situation with the first PLMN has ended. Further, the method includes sending, by second PLMN, a NAS message to the UE, wherein the NAS message comprises a cause #11(“PLMN not allowed”) indicating to the UE that the disaster condition with the first PLMN has ended.

Accordingly, the embodiment herein is to provide a UE for controlling disaster roaming service in a wireless network. The UE includes a disaster roaming service controller connected to a memory and a processor. The disaster roaming service controller is configured to detect a disaster condition on a first PLMN to trigger registration for the disaster roaming service on a second PLMN. Further, the disaster roaming service controller is configured to trigger registration for the disaster roaming service by sending a flag to the second PLMN. Further, the disaster roaming service controller is configured to camp on the second PLMN for the disaster roaming service during the disaster condition. Further, the disaster roaming service controller is configured to receive a NAS message from the second PLMN. The NAS message includes a cause #11(“PLMN not allowed”) indicating to the UE that the disaster condition has ended. Further, the disaster roaming service controller is configured to trigger a PLMN Selection procedure to camp on the first PLMN.

Accordingly, the embodiment herein is to provide a second PLMN for indicating start and end of disaster roaming service in a wireless network. The PLMN includes a disaster roaming service controller connected to a memory and a processor. The disaster roaming service controller is configured to receive a flag from the UE for registration to the disaster roaming service during a disaster situation with a first PLMN associated with the UE. Further, the disaster roaming service controller is configured to send a response allowing the UE to use the disaster roaming service during the disaster situation with the first PLMN. Further, the disaster roaming service controller is configured to detect that the disaster situation with the first PLMN has ended. Further, the disaster roaming service controller is configured to send a NAS message to the UE. The NAS message includes a cause #11(“PLMN not allowed”) indicating to the UE that the disaster condition with the first PLMN has ended.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF DRAWINGS

This embodiment is illustrated in the accompanying drawings, throughout which like reference letters indicate corresponding parts in the various figures. The embodiments herein will be better understood from the following description with reference to the drawings, in which:

FIG. 1 is an overview of a wireless network for controlling a disaster roaming service, according to an embodiment as disclosed herein;

FIG. 2 shows various hardware components of a UE, according to an embodiment as disclosed herein;

FIG. 3 shows various hardware components of a PLMN (e.g., second PLMN), according to an embodiment as disclosed herein;

FIG. 4 is a flow chart illustrating a method, implemented by the UE, for controlling the disaster roaming service in the wireless network, according to an embodiment as disclosed herein;

FIG. 5a and FIG. 5b are flow charts illustrating a method, implemented by the UE, for for indicating start and end of the disaster roaming service in the wireless network, according to an embodiment as disclosed herein;

FIG. 6 is a flow chart illustrating a method, implemented by the second PLMN, for for indicating start and end of the disaster roaming service in the wireless network, according to an embodiment as disclosed herein.

FIG. 7 is a sequence signalling diagram illustrating the scenario of selecting a disaster specific PLMN list in the automatic PLMN selection, according to the embodiments as disclosed herein;

FIG. 8 is sequence signalling diagram illustrating a scenario of improvements of PLMN selection in a network disaster scenario, according to the embodiments as disclosed herein;

FIG. 9 is a sequence signalling diagram illustrating a scenario of N3gpp access use in a disaster management, according to the embodiments as disclosed herein;

FIG. 10 is a sequence signalling diagram illustrating a scenario of a N3gpp access use in the disaster scenario where a N3gpp access is used to indicate the disaster condition to the UE and a target PLMN, according to the embodiments as disclosed herein; and

FIG. 11 is an example flow chart illustrating a scenario of a home PLMN/serving PLMN control on a disaster support, according to the embodiments as disclosed herein.

FIG. 12 is an example flow chart illustrating a scenario of a disaster support in case of roaming disabled, according to the embodiments as disclosed herein;

FIG. 13 is a sequence signalling diagram illustrating a scenario of PLMN accepting disaster inbound roamers reach maximum capacity, according to the embodiments as disclosed herein;

FIG. 14 is a sequence signalling diagram illustrating a scenario of change of PLMN providing services in the disaster situation, according to the embodiments as disclosed herein; and

FIG. 15 is a sequence signalling diagram illustrating a scenario of limit area of inbound disaster roamers to a disaster area, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for controlling disaster roaming service in a wireless network. The method includes receiving, by a UE, a disaster roaming enabled indication from a first PLMN associated with the UE. Further, the method includes detecting, by the UE, a disaster condition. Further, the method includes determining, by the UE, whether the disaster roaming enabled indication indicates that a disaster roaming is disabled in the UE or disaster roaming is enabled in the UE. In an embodiment, the method includes enabling the disaster roaming service at the UE and allowing the UE to select a PLMN for using the disaster roaming service during the disaster condition in response to determining that disaster roaming is enabled in the UE. In another embodiment, the method includes disabling the disaster roaming service at the UE, not allowing the UE to select a PLMN to receive the disaster roaming service, and entering a limited service state during the disaster condition, in response to determining that the disaster roaming is disabled in the UE.

Unlike conventional methods and systems, in the proposed method, the UE is configured with a flag from the HPLMN or the EHPLMN using a NAS signaling. If the flag indicates the UE is allowed to use a disaster roaming, during a disaster situation, the UE selects a PLMN providing the disaster roaming service and receives the disaster roaming service. If the flag indicates that the UE is not allowed to use the disaster roaming, then the UE remains in a limited service during the disaster situation. The flag is configured in the UE. This flag can be stored in a USIM or the ME. The flag can be signalled from the HPLMN to the UE using the NAS signalling. During PLMN selection procedure, the UE decides whether to select the PLMN providing disaster roaming service based on the flag or the UE decides to remain in the limited service based on the information stored in the flag. The proposed method can be used to improve the automatic PLMN selection in the disaster roaming service.

The UE is configured with the disaster PLMN list. The disaster PLMN list can be pre-configured in the UE or updated by a home network or a serving network. The disaster PLMN list is in priority order which helps the UE to determine the priority among PLMNs providing the disaster roaming service and the UE should select i.e. camp and register on.

In an embodiment, when the UE receives an indication from a serving network that the disaster services are not allowed, upon on detection of disaster, the UE should not try to attempt on such PLMN's which indicate service availability for the disaster (for example inbound roamers) (i.e., UE should not attempt for the disaster situation services).

In an embodiment, if the disaster support flag provided in the NAS or a AS message to the UE with an indication that the UE should not attempt for the disaster services is given by the HPLMN (or EHPLMN), then the UE should not attempt for receiving services on the disaster alive PLMN this can be any PLMN and not only the HPLMN which provided the indication (example PLMN-A i.e. the FPLMN providing disaster roaming service).

In an example, the disaster management situation is a condition in which either the RAN or the core network nodes are not operational due to error or natural disaster in a given area. Hence a given network which faces disaster will not be able to provide normal service to the UE. Based on the proposed method, the method includes determining that a serving PLMN is subject to disaster and a PLMN A, a PLMN B is alive without being subject to disaster (PLMN A and PLMN B is in “disaster PLMN list” for a certain UE). Further, the method includes configuring by the wireless network, the disaster PLMN list such that the PLMN A is provided higher priority than the PLMN B.

In an embodiment, if no other PLMNs available in the area, only forbidden PLMNs are available, FPLMN broadcasts that it can provide disaster roaming service on behalf of PLMN-D, then the UE will trigger registration with a new flag that it is registering for disaster roaming service.

In an embodiment, if the UE is in connected mode PLMN-A (Alive PLMN) will send a NAS message indicating to the UE that disaster situation has ended, UE after receiving NAS signaling connection release will perform PLMN Selection procedure and steer back to its HPLMN or normal PLMN Services.

In an embodiment, the conditions for the UE to trigger registration for the disaster roaming service such as a) if no other PLMNs available in the area, only forbidden PLMNs are available, b) FPLMN broadcasts that it can provide disaster roaming service, c) PLMN-D is not part of forbidden PLMN list and d) the UE is configured with an indication by the HPLMN that it is allowed to use disaster roaming service, then the UE will trigger registration with a new flag that it is registering for disaster roaming service. Due to this flag, the FPLMN AMF gets to know that the UE is registering for the disaster roaming service.

In an embodiment, when the disaster situation has ended then the AMF indicates to the UE in the NAS message using the cause value #11 a) If the UE is in the connected mode PLMN-A (i.e., Alive PLMN) will send a NAS message indicating to the UE that disaster situation has ended, b) the UE waits for the NAS signaling connection release by starting a timer, c) After receiving the NAS signaling connection release or if the timer expires (the UE performs local NAS signaling connection release). The UE add current serving PLMN to FPLMN list. The UE will perform PLMN selection procedure and steer back to its HPLMN or normal PLMN Services.

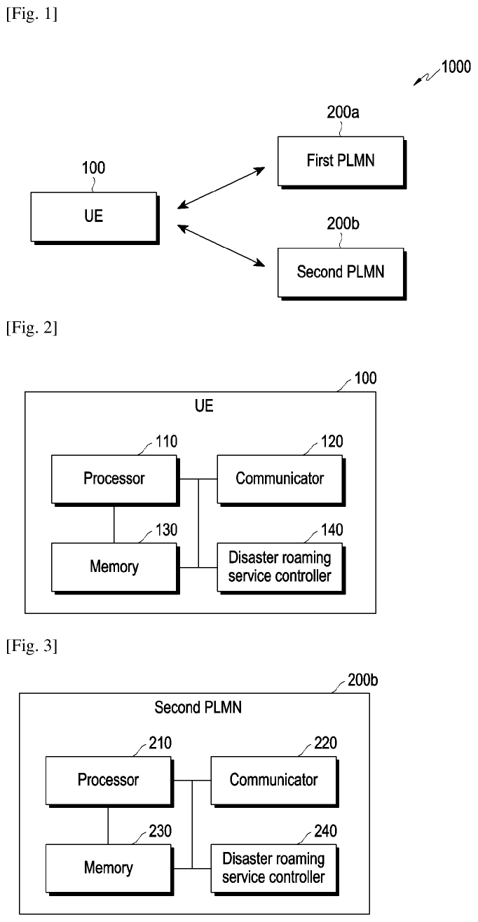

Referring now to the drawings and more particularly to FIGS. 1 through 15, where similar reference characters denote corresponding features consistently throughout the figures, there are shown preferred embodiments.

FIG. 1 is an overview of a wireless network (1000) for controlling a disaster roaming service, according to an embodiment as disclosed herein. In an embodiment, the wireless network (1000) includes a UE (100), a first PLMN (200a), and a second (200b). The first PLMN (200a) can be an EHPLMN or a HPLMN or a VPLMN (roaming partner of HPLMN which will provide services to the HPLMN subscribers). The second PLMN (200b) is a PLMN that is available to provide service when the first PLMN (200a) faces the disaster scenario. The first PLMN (200a) is associated with a first service provider, and the second PLMN (200b) is associated with a second service provider and is available in a disaster area of the first PLMN (200a).

The wireless network (1000) can be, for example, but not limited to a 2G network, a 3G network, a 4G network, a 5G network and a 6G network. The UE (100) can be, for example, but not limited to a laptop, a desktop computer, a notebook, a relay device, a Device-to-Device (D2D) device, a vehicle to everything (V2X) device, a smartphone, a tablet, an immersive device, and an internet of things (IoT) device. The UE (100) is communicated with the first PLMN (200a) and the second PLMN (200b) through wired means and/or wireless means.

The UE (100) is configured to receive a disaster roaming enabled indication from the first PLMN (200a) associated with the UE (100). Further, the UE (100) is configured to detect a disaster condition. In an embodiment, the UE (100) is configured to detect whether the disaster roaming service from an allowable PLMN is available in the wireless network (1000) to receive normal services. In another embodiment, the UE (100) is configured to detect the disaster condition when the service from an allowable PLMN is not available in the wireless network (1000) to receive the normal services and at least one FPLMN indicates the disaster roaming service is provided.

Further, the UE (100) is configured to determine whether the disaster roaming enabled indication indicates that a disaster roaming is disabled in the UE (100) or disaster roaming is enabled in the UE (100). If the disaster roaming is enabled in the UE (100), the UE (100) is configured to enable the disaster roaming service at the UE (100) and allow the UE (100) to select the second PLMN (200b) for using the disaster roaming service during the disaster condition. In an embodiment, the UE (100) is configured to select a Forbidden PLMN (FPLMN) and register with the FPLMN to receive the disaster roaming service services from the wireless network (1000).

If the disaster roaming is disabled in the UE (100), the UE (100) is configured to disable the disaster roaming service at the UE (100), not allow the UE (100) to select the second PLMN (200b) to receive the disaster roaming service, and enter a limited service state during the disaster condition,

The disaster roaming enabled indication indicates that the disaster roaming is disabled in the UE (100) due to the UE (100) is not configured with a disaster roaming enabled indication or when the disaster roaming enabled indication is configured and indicates disaster roaming disabled in the UE (100). The disaster roaming enabled indication indicates that the disaster roaming is enabled in the UE (100) if the UE (100) is configured with the disaster roaming enabled indication and indicates that the disaster roaming is enabled in the UE (100).

Further, the UE (100) is configured to store the disaster roaming enabled indication in a USIM of the UE (100) or in the ME of the UE (100). Further, the UE (100) is configured to detect a disaster condition on the first PLMN (200a) to trigger registration for the disaster roaming service on the second PLMN (200b).

In an embodiment, the UE (100) is configured to detect no other PLMN is available to provide normal services to the UE (100), except for PLMNs in the UE's forbidden PLMNs list. In another embodiment, the UE (100) is configured to detect the PLMN without the disaster condition is able to accept disaster inbound roamers from the first PLMN (200a) with the disaster condition. In another embodiment, the UE (100) is configured to detect the indication of whether disaster roaming is enabled in the UE (100) is set to “Disaster roaming is enabled in the UE (100). In another embodiment, the UE (100) is configured to detect that the first PLMN (200a) is not part of forbidden PLMN (FPLMN) lists. The UE (100) does not receive the normal services over both 3GPP access and non-3GPP access.

Further, the UE (100) is configured to trigger registration for the disaster roaming service by sending a flag to the second PLMN (200b). The flag is sent in a NAS Registration Request message with Registration Type value “Disaster Roaming”. There are two types of registration one is initial registration then Registration Type value can be called as disaster roaming initial registration and another type of registration is Mobility and periodic registration update in which case Registration Type value can be called as disaster roaming mobility registration updating. The UE (100) is configured to camp on the second PLMN (200b) for the disaster roaming service during the disaster condition. The second PLMN (200b) is configured to receive a flag from the UE (100) for registration to the disaster roaming service during the disaster situation with the first PLMN (200a) associated with the UE (100). Further, the second PLMN (200b) is configured to send the response allowing the UE (100) to use the disaster roaming service during the disaster situation with the first PLMN (200a). The second PLMN (200b) is configured to detect that the disaster situation with the first PLMN (200a) has ended. Further, the second PLMN (200b) is configured to send the NAS message to the UE (100). The NAS message comprises a cause #11(“PLMN not allowed”) indicating to the UE (100) that the disaster condition with the first PLMN (200a) has ended. The UE (100) is configured to receive the NAS message from the second PLMN (200b).

Further, the UE (100) is configured to trigger a PLMN selection procedure to camp on the first PLMN (200a). In an embodiment, the UE (100) is configured to receive a NAS signaling connection release from the second PLMN (200b) and release a NAS signaling connection with the second PLMN (200b) after receiving the NAS signaling connection release from the second PLMN (200b). Further, the UE (100) is configured to add the second PLMN (200b) in the FPLMN list and perform the PLMN selection procedure.

Further, the UE (100) is configured to start a timer to wait for the NAS signaling connection release from the second PLMN (200b) and determine whether the timer is expired. Further, the UE (100) is configured to release the NAS signaling connection with the second PLMN (200b) locally in response to determining that the timer is expired.

In an example, a PLMN D is subject to disaster and a PLMN A is alive and not subject to disaster.

In the conventional methods and systems, when the UE (100) has lost coverage of current serving PLMN or if the UE (100) identifies that disaster situation has occurred, and in a given area if more than one PLMN indicates to the UE (100) (for example by broadcast) that they support to provide disaster situation services. Which among the potential networks the UE (100) should camp and register for disaster services is not defined as per the prior art. The proposed method can be used to handle the above mentioned situation using below mechanisms:
a. If the serving network (i.e., PLMN D) faces disaster situation, then the UE (100) should do a full band scan.
b. If the other network (i.e., PLMN A) which can provide service to disaster UE's is in UE's forbidden list, then as per current implementation it will be tried in the end only after the UE (100) has exhausted all other PLMN's.
c. However, this might lead to delay in acquiring service as currently available PLMN's may not provide service to the UE (100).
d. The proposed method can be used to improve the automatic PLMN selection in the disaster scenario.

The UE (100) should be configured with the “Disaster PLMN list”. The disaster PLMN list can be pre-configured in the UE (100) or updated by the home network or the serving network. The disaster PLMN list is in the priority order which helps the UE (100) to determine which the priority disaster PLMN is and the UE (100) should select i.e. camp and register on. The wireless network (1000) can also configure a “disaster PLMN list” in the same way as done for “Steering of Roaming”.

The UE (100) must try the PLMN's as mentioned in “disaster PLMN list” which is configured by the wireless network (1000). Hence in a scenario where multiple PLMN's broadcast support for disaster UE's, the UE (100) can prioritize one PLMN over another by the help of “Disaster PLMN list” Instead of dedicated “disaster PLMN list” network can also mark or a TAG a PLMN in the OPLMN that this PLMN should be used only during disaster situation with which the UE (100) can again determine the disaster PLMN list and register with it only during the disaster situation.

If the UE (100) ever determines that disaster scenario has occurred, then the UE (100) can directly scan the disaster PLMN list, irrespective of whether the PLMN is in a FPLMN (forbidden PLMN) list or not. Below are the details:
a. If any of the PLMN's which are present in the disaster PLMN list is found, then the UE (100) should try those PLMN's on priority as long as disaster situation exists.
b. This not only improves the time required to acquire service in case of disaster but also calls for easier implementation in the UE side (100).
c. This list should only be considered when a disaster situation occurs.

In the proposed method (as shown in the FIG. 7), the serving PLMN is subject to disaster and PLMN A and PLMN B is alive and not subject to disaster (PLMN A and PLMN B is in “disaster PLMN list”) and for a certain UE (100), the wireless network (1000) configures the disaster PLMN list in such a way that the PLMN A has higher priority than PLMN B. The serving PLMN here can be HPLMN or VPLMN.

In the conventional methods and the systems, there are other problems that might happen. In an example, if PLMN D wants to use 2 PLMN's to distribute its users of the UE (100) in the disaster situation, then that is also not possible currently because the UE (100) will try other PLMN's which are not in preferred list randomly.

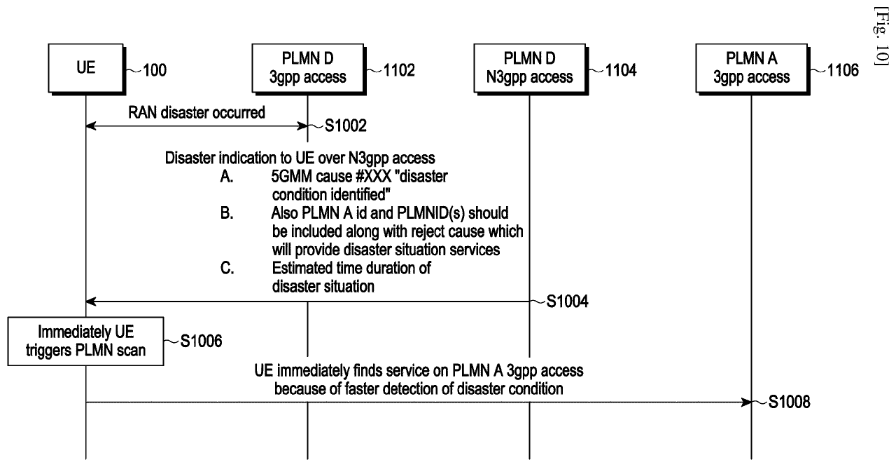

Unlike to the conventional methods and systems, (referring to the FIG. 9), in the proposed method, the PLMN D is subject to disaster and PLMN A is alive and not subject to disaster and providing services to disaster affected UE's of PLMN D. The PLMN B is random PLMN available in same region.

The improvements methods are as follows:
1. If the serving network (i.e., PLMN D) faces a core network disaster, then the serving network can inform the UEs (100) through either broadcast (SIB) or through specific cause #XXX “disaster condition identified” as part of the NAS or the AS signaling message.
2. The serving PLMN can also include the target PLMN id(s) which is expected to provide disaster service to the UE (100) as long as disaster condition prevails.
3. The UE (100) can then prioritize such PLMN's (even though it is in FPLMN list) over others and hence reduce the time wasted in attempting other PLMN's which may not provide service to the UE (100).
4. The wireless network (1000) can also give different PLMN ids to different subscribers so that it can distribute its users among various service providers in the same region.
5. The wireless network (1000) can also provide the timer indicating the expected disaster situation duration, after the expiry of the timer, the UE (100) should attempt to register back to its regular PLMNs for normal service.

In the conventional methods, the N3gpp Access use in disaster scenario are as follows:
1. If the PLMN D faces a RAN disaster, then it might take the UE (100) a long time to know that a disaster has actually occurred. In an example, the UE (100) is trying the registration and the RAN disaster has occurred. Only after retrying 5 times and waiting for response, the UE (100) will conclude that a disaster situation has been encountered in the RAN of PLMN D. This will delay the time it takes for the UE (100) to acquire the service. Also, when the UE (100) is registered over PLMN A which is accepting disaster inbound roamers, then due to the large amount of users accessing 3gpp RAN, there might be an adverse effect on data speeds due to RAN limitation.

The proposed method describes how the user of the UE (100) can use N3gpp access to address the above issues. In the proposed methods, (as shown in the FIG. 9) the PLMN D is subject to disaster and PLMN A is alive and not subject to disaster and providing services to disaster affected UE's of PLMN D. The methods are as follows:
1. If the serving network (PLMN D) faces disaster situation over the RAN, then the wireless network (1000) can indicate the same to UEs (100) over the N3gpp access (1104) in the NAS message like UE configuration update or DL NAS transport etc. The target PLMN id(s) can also be included so that the UE (100) can access target PLMN faster.
2. So if the user of the UE (100) is connected to the N3gpp access (100) simultaneously, then the UE (100) will immediately come to know that a disaster situation has occurred.
3. Also since there will be huge load on the PLMN A which is accepting the disaster inbound roamers, hence there might be special provisioning in the URSP rules for the disaster scenarios, if it is needed to offload PDU's to N3gpp access in disaster situation. Since the URSP rules are configured by the HPLMN (200a), the disaster handling of PDU's should also be clarified in URSP rules. Similar to access type preference, there should be another parameter in the route selection descriptor which indicates the access type preference in the disaster situation for each PDU session.

The below example table 1 represents a USRP in the disaster scenario.

TABLE 1

| | | | PCF | |
|---|---|---|---|---|
| | | | permitted | |
| Information | | | to modify | |
| name | Description | Category | in URSP | Scope |
| Route | Determines the | Mandatory | Yes | UE |
| selection | order in which the | | | context |
| descriptor | route selection | | | |
| precedence | descriptors are to be | | | |
| | applied. | | | |
| Route | This part defines the | Mandatory | | |
| selection | route selection | | | |
| components | components | | | |
| SSC mode | One single value of | Optional | Yes | UE |
| selection | SSC mode. | | | context |
| Network slice | Either a single value | Optional | Yes | UE |
| selection | or a list of values of | | | context |
| | S-NSSAI(s). | | | |
| DNN selection | Either a single value | Optional | Yes | UE |
| | or a list of values of | | | context |
| | DNN(s). | | | |
| PDU session | One single value of | Optional | Yes | UE |
| type selection | PDU Session Type | | | context |
| Non-seamless | Indicates if the | Optional | Yes | UE |
| offload | traffic of the | | | context |
| indication | matching | | | |
| | application is to be | | | |
| | offloaded to non- | | | |
| | 3GPP access outside | | | |
| | of a PDU Session. | | | |
| Access type | Indicates the | Optional | Yes | UE |
| preference | preferred Access | | | context |
| | Type (3GPP or non- | | | |
| | 3GPP or Multi- | | | |
| | Access) when the | | | |
| | UE establishes a | | | |
| | PDU session for the | | | |
| | matching | | | |
| | application. | | | |
| Route | This part defines the | Optional | Yes | UE |
| selection | route validation | | | context |
| validation | criteria components | | | |
| criteria | | | | |
| Time window | The time window | Optional | Yes | UE |
| | when the matching | | | context |
| | traffic is allowed. | | | |
| | The RSD is not | | | |
| | considered to be | | | |
| | valid if the current | | | |
| | time is not in the | | | |
| | time window. | | | |
| Location | The UE location | Optional | Yes | UE |
| criteria | where the matching | | | context |
| | traffic is allowed. | | | |
| | The RSD rule is not | | | |
| | considered to be | | | |
| | valid if the UE | | | |
| | location does not | | | |
| | match the location | | | |
| | criteria. | | | |

In the proposed method (as shown in the FIG. 9), the disaster rules provided in the URSP to indicate the user about the PDU session offloading during disaster. Further, the PLMN D is subject to disaster and PLMN A is alive and not subject to disaster and providing services to disaster affected UE's of PLMN D.

In the conventional methods, the home PLMN/serving PLMN control on the disaster support containing the following steps:
a. As per the conventional methods, the serving PLMN has no control on which the users of the UE (100) can access other PLMN's during the disaster situation.
b. However, such a control is very much necessary as there might be some UE's (100) which have no valid subscription/validity expired which are not allowed to get any services other than emergency services from the wireless network (1000).
c. In case of disaster the PLMN accepting disaster inbound roamers might not be able to fetch the subscription of all UE's (100) from the home network as there may not be any agreement between the home network and other network serving UE's (100) during the disaster.
d. In such cases the UE's (100) which would have otherwise not got any service because of subscription issue will start getting services and the home network will be charged by other network which provides such services in disaster situation.

Unlike to the conventional methods and systems, the home PLMN/the serving PLMN control on the disaster support are as follows:
1. In cases where the certain UE (100) has no valid subscription, the serving network can include a parameter (i.e., disaster support) in attach accept/attach reject (e.g., NAS/AS signaling) that it is not allowed to access other network in the disaster situation.
2. When the UE (100) receives an indication from the serving network that the disaster services are not allowed, then on detection of disaster, the UE (100) should not try to attempt on such PLMN's which indicate service availability for the disaster (for example inbound roamers) (i.e. the UE (100) should not attempt for the disaster situation services.
3. In yet another embodiment, when the UE (100) receives an indication from the serving network that the disaster services are not allowed, then on detection of disaster, the UE (100) should not try to attempt on such PLMN's which indicate service availability for disaster inbound roamers unless and until such PLMN's are part of preferred PLMN list.
4. If the disaster support flag provided in the NAS or AS message to the UE (100) with an indication “that the UE (100) should not attempt for the disaster services” is given by a VPLMN D, then the UE (100) should not attempt for receiving services on disaster alive PLMN (example PLMN-A) which provides services on behalf of VPLMN-D (for example when the VPLMN-A broadcasts that it is providing disaster situation services for the VPLMN D when PLMN-D has faced disaster situation).
5. In yet another embodiment, if the disaster support flag provided in the NAS or AS message to the UE (100) with an indication “that the UE (100) should not attempt for the disaster services” is given by the HPLMN (200a) (or the EHPLMN (200b)), then the UE (100) should not attempt for receiving services on the disaster alive PLMN this can be any PLMN and not only the HPLMN (200a) which provided the indication (example PLMN-A).
6. In yet another embodiment, if the disaster support flag provided in the NAS or AS message to the UE (100) with an indication “that the UE (100) should not attempt for disaster services” is given by the VPLMN D, then the UE (100) should not attempt for receiving services on any of the available disaster alive PLMN (example PLMN-A) which provides services on behalf of the VPLMN-D (for example when the VPLMNA broadcasts that it is providing disaster situation services for the VPLMN D when the PLMN-D has faced disaster situation).

FIG. 2 shows various hardware components of the UE (100), according to an embodiment as disclosed herein. In an embodiment, the UE (100) includes a processor (110), a communicator (120), a memory (130) and a disaster roaming service controller (140). The processor (110) is coupled with the communicator (120), the memory (130), and the disaster roaming service controller (140).

The disaster roaming service controller (140) is configured to receive the disaster roaming enabled indication from the first PLMN (200a) associated with the UE (100). Further, the disaster roaming service controller (140) is configured to detect the disaster condition. In an embodiment, the disaster roaming service controller (140) is configured to detect whether the disaster roaming service from the allowable PLMN is available in the wireless network (1000) to receive normal services. In another embodiment, the disaster roaming service controller (140) is configured to detect the disaster condition when the service from the allowable PLMN is not available in the wireless network (1000) to receive the normal services and at least one FPLMN indicates the disaster roaming service is provided.

Further, the disaster roaming service controller (140) is configured to determine whether the disaster roaming enabled indication indicates that the disaster roaming is disabled in the UE (100) or disaster roaming is enabled in the UE (100). If the disaster roaming is enabled in the UE (100), the disaster roaming service controller (140) is configured to enable the disaster roaming service at the UE (100) and allow the UE (100) to select the second PLMN (200b) for using the disaster roaming service during the disaster condition. In an embodiment, the disaster roaming service controller (140) is configured to select the FPLMN and register with the FPLMN to receive the disaster roaming service services from the wireless network (1000).

If the disaster roaming is disabled in the UE (100), the disaster roaming service controller (140) is configured to disable the disaster roaming service at the UE (100), not allowing the UE (100) to select the second PLMN (200b) to receive the disaster roaming service, and enter a limited service state during the disaster condition,

Further, the disaster roaming service controller (140) is configured to store the disaster roaming enabled indication in the USIM of the UE (100) or in the UE (100).

Further, the disaster roaming service controller (140) is configured to detect the disaster condition on the first PLMN (200a) to trigger registration for the disaster roaming service on the second PLMN (200b). In an embodiment, the disaster roaming service controller (140) is configured to detect no other PLMN is available to provide normal services to the UE (100), except for PLMNs in the UE's forbidden PLMNs list. In another embodiment, the disaster roaming service controller (140) is configured to detect the PLMN without the disaster condition is able to accept disaster inbound roamers from the first PLMN (200a) with the disaster condition. In another embodiment, the disaster roaming service controller (140) is configured to detect the indication of whether disaster roaming is enabled in the UE (100) is set to “Disaster roaming is enabled in the UE (100). In another embodiment, the disaster roaming service controller (140) is configured to detect that the first PLMN (200a) is not part of forbidden PLMN (FPLMN) lists. The UE (100) does not receive the normal services over both 3GPP access and non-3GPP access.

Further, the disaster roaming service controller (140) is configured to trigger registration for the disaster roaming service by sending the flag to the second PLMN (200b). The flag is sent in the NAS Registration Request message with Registration Type value “Disaster Roaming”. The disaster roaming service controller (140) is configured to camp on the second PLMN (200b) for the disaster roaming service during the disaster condition. The disaster roaming service controller (140) is configured to receive the NAS message from the second PLMN (200b). The NAS message includes the cause #11(“PLMN not allowed”) indicating to the UE (100) that the disaster condition has ended.

The disaster roaming service controller (140) is configured to trigger the PLMN selection procedure to camp on the first PLMN (200a). In an embodiment, the disaster roaming service controller (140) is configured to receive the NAS signaling connection release from the second PLMN (200b) and release the NAS signaling connection with the second PLMN (200b) after receiving the NAS signaling connection release from the second PLMN (200b). Further, the disaster roaming service controller (140) is configured to add the second PLMN (200b) in the FPLMN list and perform the PLMN selection procedure.

Further, the disaster roaming service controller (140) is configured to start the timer to wait for the NAS signaling connection release from the second PLMN (200b) and determine whether the timer is expired. Further, the disaster roaming service controller (140) is configured to release the NAS signaling connection with the second PLMN (200b) locally in response to determining that the timer is expired.

The disaster roaming service controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

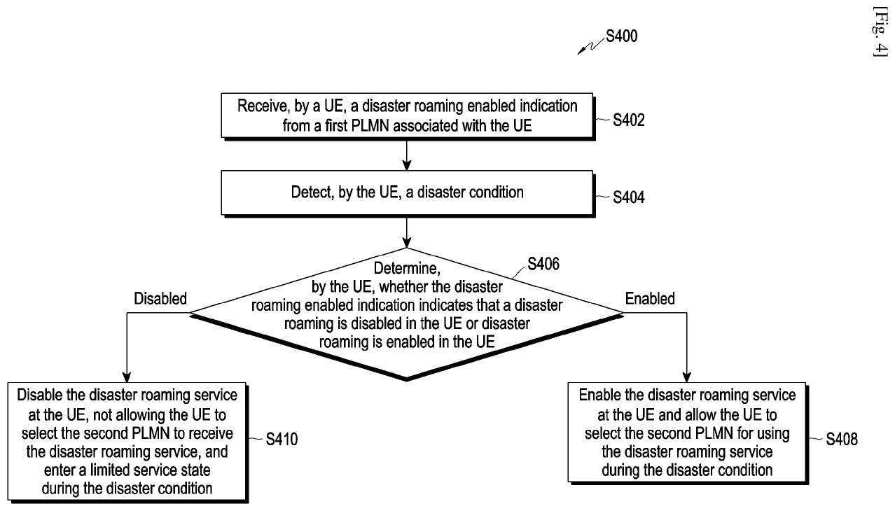

FIG. 3 shows various hardware components of the second PLMN (200b), according to an embodiment as disclosed herein. In an embodiment, the second PLMN (200b) includes a processor (210), a communicator (220), a memory (230) and a disaster roaming service controller (240). The processor (210) is coupled with the communicator (220), the memory (230), and the disaster roaming service controller (240).

The disaster roaming service controller (240) is configured to receive the flag from the UE (100) for registration to the disaster roaming service during the disaster situation with the first PLMN (200a) associated with the UE (100). Further, the disaster roaming service controller (240) is configured to send the response allowing the UE (100) to use the disaster roaming service during the disaster situation with the first PLMN (200a). Further, the disaster roaming service controller (240) is configured to detect that the disaster situation with the first PLMN (200a) has ended. Further, the disaster roaming service controller (240) is configured to send the NAS message to the UE (100). The NAS message comprises the cause #11(“PLMN not allowed”) indicating to the UE (100) that the disaster condition with the first PLMN (200a) has ended.

The disaster roaming service controller (240a) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the second PLMN (200b) but it is to be understood that other embodiments are not limited thereon. In other embodiments, the second PLMN (200b) may include less or more number of components. Further, the labels or names of the components are used only for illustrative purpose and does not limit the scope of the invention. One or more components can be combined together to perform same or substantially similar function in the second PLMN (200b).

FIG. 4 is a flow chart (S400) illustrating a method, implemented by the UE (100), for controlling the disaster roaming service in the wireless network (1000), according to an embodiment as disclosed herein. The operations (S402-S410) are handled by the disaster roaming service controller (140).

At S402, the method includes receiving the disaster roaming enabled indication from the first PLMN (200a) associated with the UE (100). At S404, the method includes detecting the disaster condition. At S406, the method includes determining whether the disaster roaming enabled indication indicates that the disaster roaming is disabled in the UE (100) or disaster roaming is enabled in the UE (100).

In response to the disaster roaming is enabled in the UE (100) then, at S408, the method includes enabling the disaster roaming service at the UE (100) and allowing the UE (100) to select the second PLMN (200b) for using the disaster roaming service during the disaster condition.

In response to the disaster roaming is disabled in the UE (100), at S410, the method includes disabling the disaster roaming service at the UE (100), not allowing the UE (100) to select the second PLMN (200b) to receive the disaster roaming service, and entering the limited service state during the disaster condition.

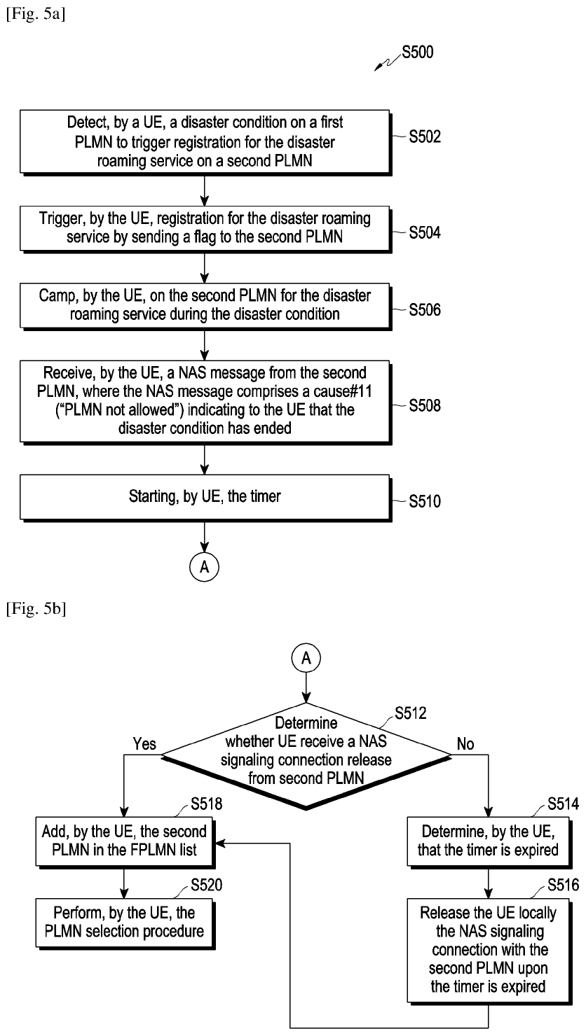

FIG. 5a and FIG. 5b are flow charts (S500) illustrating a method, implemented by the UE (100), for for indicating start and end of disaster roaming service in the wireless network (1000), according to an embodiment as disclosed herein. The operations (S502-S522) are handled by the disaster roaming service controller (140).

At S502, the method includes detecting the disaster condition on the first PLMN (200a) to trigger registration for the disaster roaming service on the second PLMN (200b). At S504, the method includes triggering the registration for the disaster roaming service by sending the flag to the second PLMN (200b). At S506, the method includes camping on the second PLMN (200b) for the disaster roaming service during the disaster condition.

At S508, the method includes receiving the NAS message from the second PLMN (200b). The NAS message comprises the cause #11(“PLMN not allowed”) indicating to the UE (100) that the disaster condition has ended. At S510, the method includes starting the timer. At S512, the method includes determining whether the UE (100) receives the NAS signaling connection release from the second PLMN. In response to determining that the UE (100) does not receive the NAS signaling connection release from the second PLMN then, at S514, the method includes determining that the timer is expired. At S516, the method includes releasing the UE locally the NAS signaling connection with the second PLMN upon the timer is expired. In response to determining that the UE (100) receives the NAS signaling connection release from the second PLMN then, at S518, the method includes adding the second PLMN in the FPLMN list. At S520, the method includes performing the PLMN selection procedure.

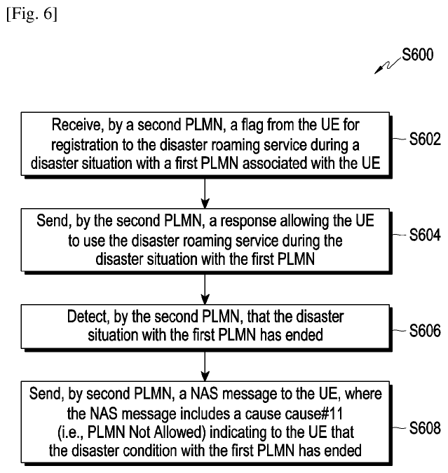

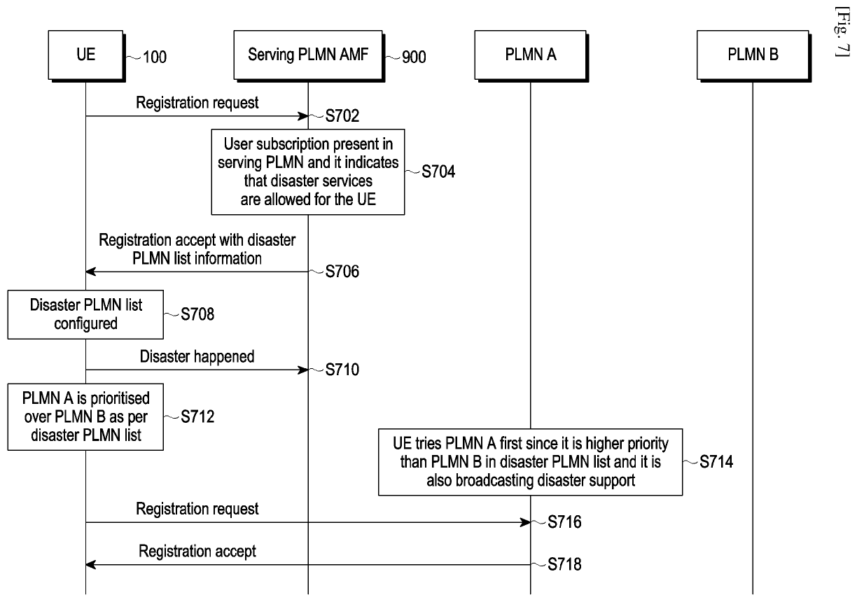

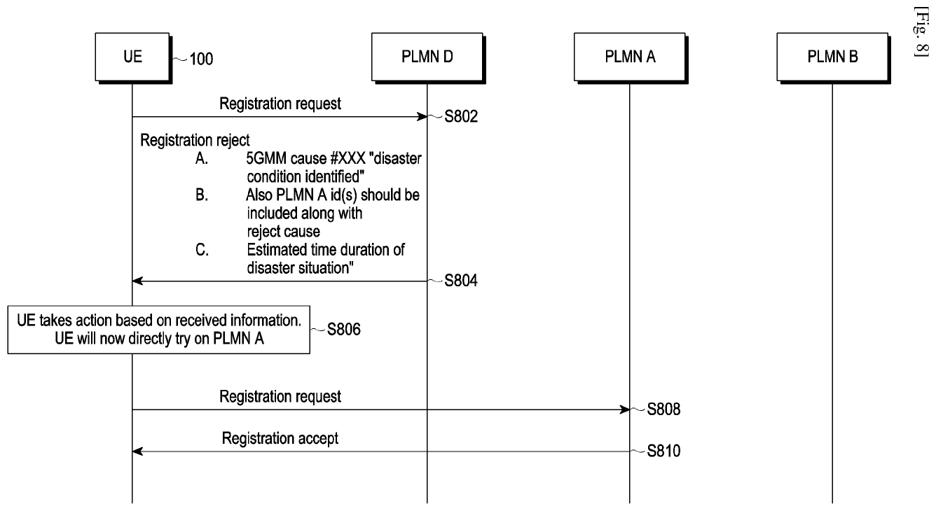

FIG. 6 is a flow chart (S600) illustrating a method, implemented by the second PLMN (200b), for for indicating start and end of disaster roaming service in the wireless network (1000), according to an embodiment as disclosed herein. The operations (S602-S608) are handled by the disaster roaming service controller (240).

At S602, the method includes receiving the flag from the UE (100) for registration to the disaster roaming service during the disaster situation with the first PLMN (200a) associated with the UE (100). At S604, the method includes sending the response allowing the UE (100) to use the disaster roaming service during the disaster situation with the first PLMN (200a). At S606, the method includes detecting that the disaster situation with the first PLMN (200a) has ended. At S608, the method includes sending the NAS message to the UE (100). The NAS message includes the cause #11 (PLMN Not Allowed) indicating to the UE (100) that the disaster condition with the first PLMN (200a) has ended.

FIG. 7 is a sequence signalling diagram illustrating the scenario of selecting the disaster specific PLMN list in the automatic PLMN selection, according to the embodiments as disclosed herein. At S702, the UE (100) sends the registration request with the serving PLMN AMF (900). At S704, the user subscription present in the serving PLMN (200c) and the PLMN AMF (900) indicates that the disaster services are allowed for the UE (100). At S706, the serving PLMN AMF (900) sends the registration accept with the disaster PLMN list information. At S708, the disaster PLMN list is configured at the UE (100). At S710, the disaster is happened between the UE (100) and the serving PLMN (900). At S712, the PLMN A is prioritised over the PLMN B as per disaster PLMN list. At S714, the UE (100) tries the PLMN A first since the PLMN A is higher priority than the PLMN B in the disaster PLMN list and the PLMN A is also broadcasting the disaster support. At S716, the UE (100) sends the registration request with the PLMN A. At S718, the PLMN A sends the registration accept to the UE (100).

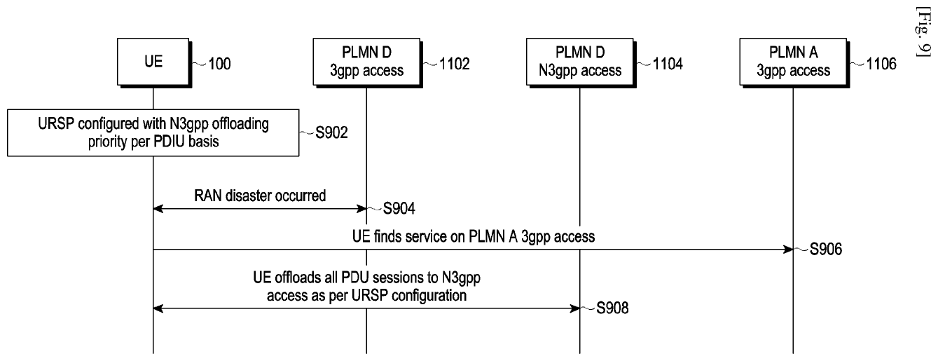

FIG. 8 is a sequence signalling diagram illustrating a scenario of improvements of PLMN selection in a network disaster scenario, according to the embodiments as disclosed herein. At S802, the UE (100) sends the registration request to the PLMN D. At S804, the PLMN D sends the registration reject to the UE (100). The registration reject is provided with the cause value (i.e., 5GMM cause #XXX “disaster condition identified, PLMN A id(s) should be included along with the reject cause, and estimated time duration of disaster situation). At S806, the UE (100) takes action based on the received information. The UE (100) will now directly try on the PLMN A. At S808, the UE (100) sends the registration request to the PLMN A. At S810, the PLMN A sends the registration accept to the UE (100).

FIG. 9 is a sequence signalling diagram illustrating a scenario of N3gpp access use in the disaster management, according to the embodiments as disclosed herein. At S902, the URSP is configured with the N3gpp offloading priority per PDIU basis. At S904, a RAN disaster is occurred between the UE (100) and the PLMN D 3gpp access (1102). At S906, the UE (100) finds the service on the PLMN A 3gpp access (1106). At S908, the UE (100) offloads all PDU sessions to the PLMN D N3gpp access (1104) as per the URSP configuration.

FIG. 10 is a sequence signalling diagram illustrating a scenario of N3gpp access use in the disaster scenario where a PLMN D N3gpp access (1104) is used to indicate the disaster condition to the UE (100) and the target PLMN, according to the embodiments as disclosed herein.

At 51002, the RAN disaster is occurred between the UE (100) and the PLMN D 3gpp access (1102). At 51004, the PLMN D N3gpp access (1104) sends the disaster indication to the UE (100) over the N3gpp access. The the disaster indication is provided with the cause value (i.e., 5GMM cause #XXX “disaster condition identified”, PLMN A id and PLMNID(s) should be included along with the reject cause which will provide disaster situation services, and estimated time duration of disaster situation. At 51006, the UE (100) immediately triggers the PLMN scan. At 51008, the UE (100) immediately finds the service on the PLMN A 3gpp access (1106) because of faster detection of disaster condition.

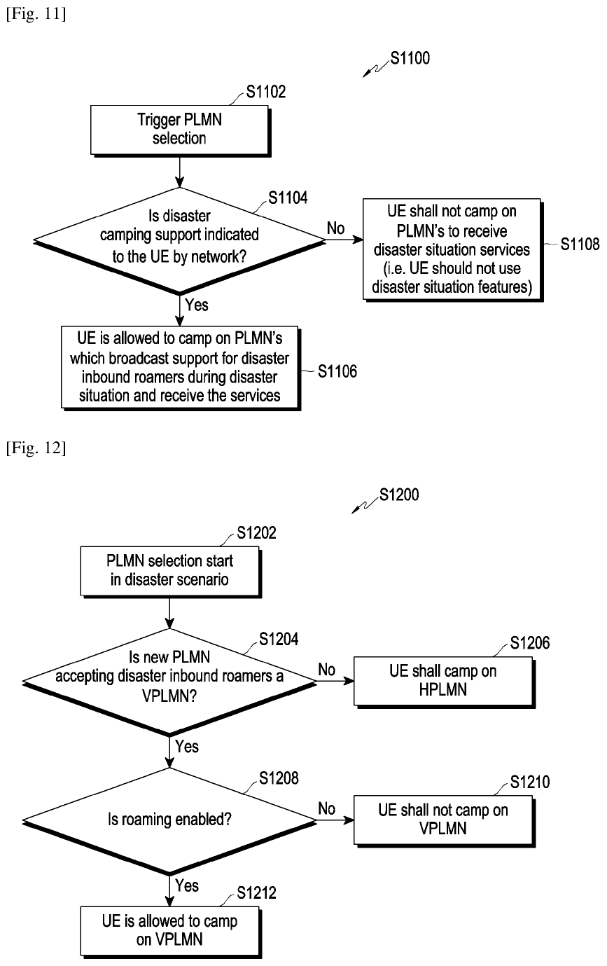

FIG. 11 is an example flow chart (S1100) illustrating a scenario of home PLMN (200a)/the serving PLMN (200c) control on the disaster support, according to the embodiments as disclosed herein. The operations (S1102 to S1108) are handled by the disaster roaming service controller (140).

At S1102, the method includes triggering the PLMN selection. At 51104, the method includes determining whether the disaster camping support is indicated to the UE (100) by the wireless network (1000)? If the disaster camping support is indicated to the UE (100) by the wireless network (1000) then, at 51106, the UE (100) is allowed to camp on the PLMN's which broadcast support for disaster inbound roamers during the disaster situation and receives the services. If the disaster camping support is not indicated to the UE (100) by the wireless network (1000) then, at S1108, the UE (100) shall not camp on the PLMN's to receive disaster situation services (i.e. UE (100) should not use disaster situation features).

In the conventional methods and systems, the serving PLMN can enter into an agreement with any PLMN during disaster situation. Hence it might be possible that the agreement between disaster PLMN and PLMN accepting disaster inbound roamers may be such that the new PLMN can either be HPLMN/VPLMN. As per the conventional methods and systems, there is no mention on whether the UE should treat new PLMN as roaming PLMN/HPLMN. In such a situation, if disaster happens on HPLMN and the PLMN which accepts disaster inbound roamers is a VPLMN, then there is no clear handling whether the UE should select such a PLMN or not based on roaming enabled/disabled setting in device.

In an example, the PLMN-D is a PLMN which has faced disaster situation, the PLMN-A is a PLMN which is an active PLMN providing services on behalf of PLMN (PLMN-A) which has faced disaster situation.

An operator controlled PLMN selector with Access Technology (OPLMN), User Controlled PLMN Selector with Access Technology (UPLMN), Home PLMN (HPLMN), Equivalent Home PLMN (EHPLMN) are the abbreviations used here after. The conditions to determine the disaster based service by the UE (100):
A. Currently configured PLMNs part of HPLMN, EHPLMN, UPLMN, OPLMN are not available in the area and all other PLMNs in the area are in Forbidden PLMN (FPLMN) list and FPLMN(PLMN-A) is broadcasting that it will provide disaster based service(optionally indicating for PLMN-D); or
B. Currently configured PLMNs part of HPLMN, EHPLMN, UPLMN, and OPLMN are not available and there are only Random PLMNs which are indicating that they are providing disaster support(optionally indicating for PLMN-D);
a. Optionally for all above cases UE (100) checks if the PLMN-D is not part of FPLMN list. If the PLMN D is already part of FPLMN list, the UE (100) will not trigger registration on PLMN-A for disaster services.
b. Then the UE (100) should attempt for registration for disaster services with the flag (i.e. an indication in the information element (IE)) to the PLMN-A that it's registering for disaster based service as PLMN-D is not available. Optionally only if PLMN-D is not part of FPLMN list.

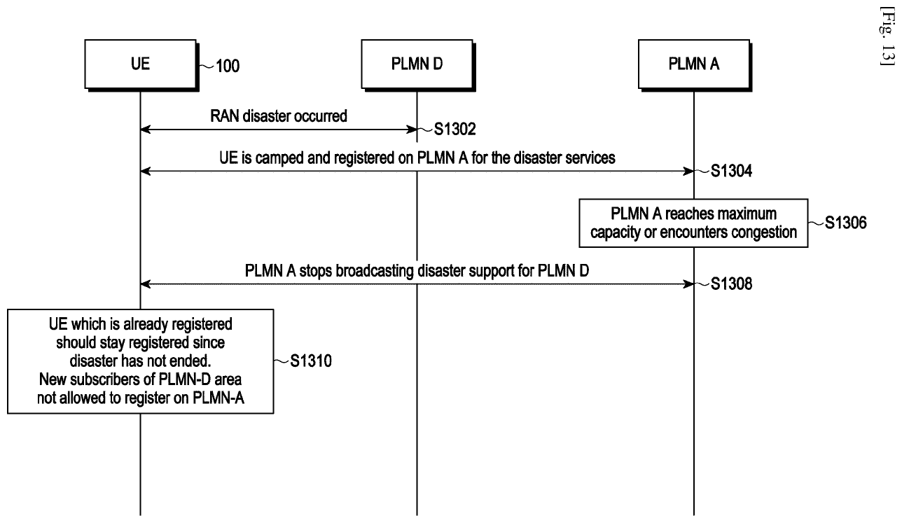

FIG. 12 is an example flow chart (S1200) illustrating a scenario of the disaster support in case of roaming disabled, according to the embodiments as disclosed herein.

Unlike to the conventional methods and systems, referring to the FIG. 12 consider a proposed method describes the PLMN selection techniques for disaster cases in the roaming disabled scenario. Followings are the steps in detail:
1. The UE (100) must treat the new PLMN with respect to current lists that are configured in the UE (100). These pre-configured lists which are stored in the UE (100) are UPLMN/OPLMN/HPLMN/EHPLMN.
2. If the new PLMN, which is accepting disaster inbound roamers, is determined to be a VPLMN, then the UE (100) should check its roaming capabilities before attempting such the PLMN in the disaster situation. If roaming is disabled for the UE (100) then UE (100) shall not camp on the VPLMN(PLMN-A) even if it is providing disaster based services on behalf of PLMN-D(which is home PLMN(HPLMN)/Equivalent (E)HPLMN) of the UE (100).
3. In yet another embodiment, as the PLMN-D has faced disaster situation and the UE (100) has determined it, the UE (100) should indicate this to the user including the information about PLMN-A after users consent the UE (100) should attempt to acquire disaster roaming services from PLMN-A.
4. In yet another embodiment, as the PLMN-D has faced disaster situation and the UE (100) has determined it, the UE (100) should attempt to acquire services from the PLMN-A and should not consider it to be as a roaming PLMN i.e. the UE (100) can consider both this PLMNs are equivalent from service perspective i.e. HPLMN=VPLMN for roaming procedures and the UE handling perspective i.e. for example roaming icon is disabled.
5. In yet another embodiment as the PLMN-D has faced disaster situation and UE (100) has determined it, the UE (100) should attempt to acquire services from the PLMN-A but it continuous to indicate the UE (100) is in the roaming are to the user in an user interface.

Referring to the FIG. 12, at 51202, the UE (100) starts the PLMN selection in the disaster scenario. At 51204, the UE (100) determines whether the new PLMN accepting disaster inbounds roamers the VPLMN? If the new PLMN does not accept the disaster inbounds roamers the VPLMN then, at 51206, the UE (100) shall camp on the HPLMN.

If the new PLMN accepts the disaster inbounds roamers the VPLMN then, at 51208, the UE (100) determines whether the roaming is enabled? If the roaming does not enabled then, at 51210, the UE (100) shall not camp on the VPLMN. If the roaming is enabled then, at 51212, the UE (100) is allowed to camp on the VPLMN.

When the PLMN accepting disaster inbounds roamers reach maximum capacity, then there should be a method to stop accepting new UE's so that the services of already registered UE's are not affected for both inbound roamers and network's own subscribers. There is no existing method to solve this problem.

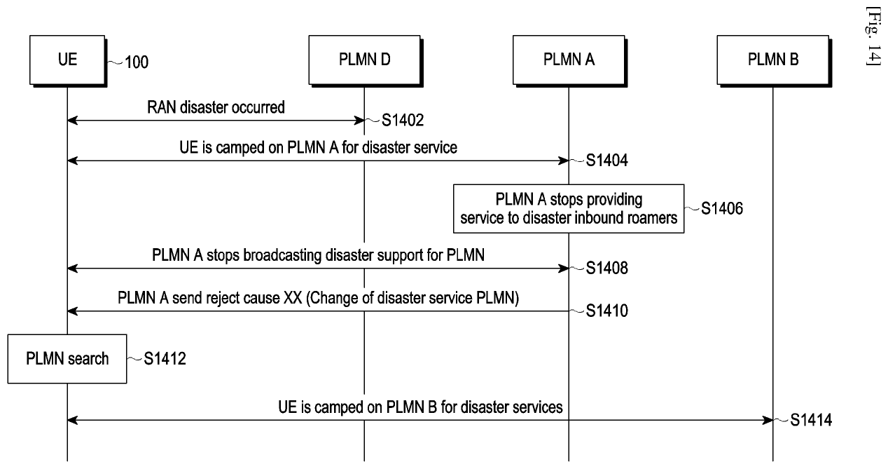

FIG. 13 is a sequence signalling diagram illustrating a scenario of PLMN accepting disaster inbound roamers reach maximum capacity, according to the embodiments as disclosed herein.

Unlike to the conventional methods and systems, referring to the FIG. 13, in the proposed method, the PLMN D is subject to disaster and PLMN A is alive and not subject to disaster and providing services to disaster affected UE's of PLMN D. Followings are the steps in detail:
1. When the PLMN-A accepting disaster inbound roamers reach maximum capacity(or faced congestion situation), then there should be a method to stop accepting new UE's so that services of already registered UE's are not affected.
2. The PLMN-A can stop broadcasting disaster support for inbound UE's.
3. In such a case the UE's which are already registered in the PLMN for disaster services should not detect that disaster situation has ended. The UE's currently registered in the PLMN should be able to get services in the disaster area normally without any interruption. i.e., UEs which are using registered with PLMN-A neglect any changes to the broadcast of support to disaster based services and continue to obtain the registered services by triggering required NAS procedures like Service request.
4. In yet another embodiment, if the broadcast stopped by PLMN-A that it supports disaster service for PLMN-D then, the UE (100) is not allowed to trigger initial registration but its allowed to trigger TAU (REGISTRATION for mobility or periodic registration) or any other NAS procedure for the UEs which are already registered with PLMN-A (i.e. for subscribers or inbound roamers of PLMN-D).
5. This is also a way to control congestion in PLMN which is providing disaster services in a disaster situation.

When the PLMN accepting disaster inbound roamers wants to stop providing services due to a technical issue or congestion or some other agreement between disaster PLMN and other PLMNs in existing region then the serving PLMN should be able to indicate same to the UE, so that the UE (100) can do a PLMN search and acquire disaster time services on some other PLMN in the same region.

Referring to the FIG. 13, at 51302, the RAN disaster occurs between the UE (100) and the PLMN D. At S1304, the UE (100) is camped and registered on the PLMN A for the disaster services. At 51306, the PLMN A reaches maximum capacity or encounters congestion. At 51308, the PLMN A stops broadcasting disaster support for the PLMN D. At 51310, the UE (100) which is already registered should stay registered since disaster has not ended. The new subscribers of PLMN-D area not allowed to register on the PLMN-A.

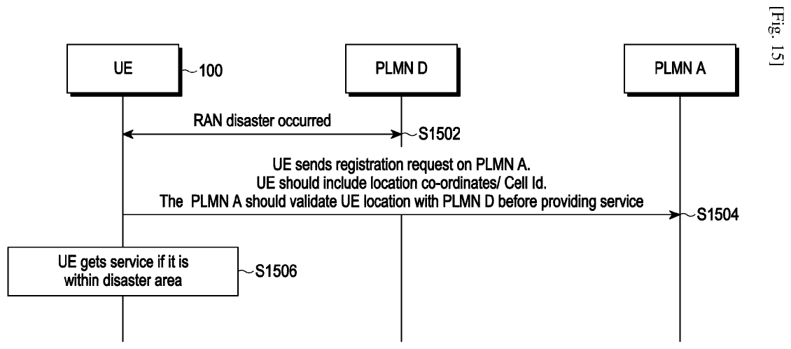

FIG. 14 is a sequence signalling diagram illustrating a scenario of change of PLMN providing services in disaster situation, according to the embodiments as disclosed herein.

Unlike to the conventional methods and systems, referring to the FIG. 14, in a proposed method, the PLMN D is subject to disaster and PLMN A is alive and not subject to disaster and providing services to disaster affected UE's of PLMN D. Now PLMN A wants to stop providing services to all disaster inbound roamers because PLMN B is providing services to disaster affected UE's of PLMN D as per new agreement. Followings are the steps in detail:
1. When the PLMN accepting disaster inbound roamers (PLMN A) wants to stop providing services due to a technical issue or some other agreement between disaster PLMN (PLMN D) and other PLMNs in existing region, then the serving PLMN can provide a Reject cause #XX (Change of Disaster Service PLMN) in a NAS message to the UE (100) and also stop broadcasting disaster support for PLMN D so that no new UE's try to register on PLMN A optionally disaster bit is not stopped broadcasting.
2. The UE (100) on receiving such a cause should optionally trigger detach after release of NAS signaling connection or by performing local signaling connection release.
3. The UE (100) should then add this PLMN to temp Blocked PLMN list and search other PLMN's in the same area that broadcast support for disaster services. The PLMN is blocked till a guard timer which is governed by a timer pre-configured in the UE (100) or guard timer can be provided by the network (1000).
4. When broadcast is disabled:
a) UE (100) in an idle mode—It should not trigger any NAS procedure towards PLMN-A and it should perform PLMN selection and try to acquire services from some other PLMN.
b) UE (100) in a connected mode—the serving PLMN can provide a Reject cause #XX(Change of Disaster Service PLMN) in a NAS message to the UE (100) and also stop broadcasting disaster support for PLMN D so that no new UE's try to register on PLMN A.
c) The current serving PLMN can be populated in FPLMN list.

Unlike to the conventional methods and systems, referring to the proposed method, describes the PLMN D which is subject to disaster and PLMN A is alive and not subject to disaster and providing services to disaster affected UE's of PLMN D. Followings are the steps in detail:
1. In an embodiment, the UE (100) can be configured (in SIM or ME) with a MAX timer value for timer T(i.e. higher priority PLMN search guard timer to acquire higher priority PLMNs) to be used in case of disaster situation i.e. when the UE (100) is registered for disaster services on PLMN-A. So that recovery to Higher Priority PLMN or HPLMN (or EHPLMN) is done as early as possible. The MAX timer value can be provided to the UE (100) by the HPLMN following SOR kind of procedure i.e. HPLMN provides this value to VPLMN and VPLMN delegates the timer value to the UE (100) in one of the NAS or AS message. The MAX timer value can be randomized by HPLMN so that not all the UEs attack the HPLMN at the same time for acquiring service. Optionally the MAX timer value can be independent of the disaster situation or not and can be configured in the UE (ME or USIM) by HPLMN.

Referring to the FIG. 14, at 51402, the RAN disaster occurs between the UE (100) and the PLMN D. At 51404, the UE (100) is camped on the PLMN A for the disaster services. At 51406, the PLMN A stops providing service to disaster inbound roamers. At 51408, the PLMN A stops broadcasting disaster support for the PLMN. At 51410, the PLMN-A sends reject cause XX (Change of disaster service PLMN) to the UE (100). At 51412, the UE (100) performs the PLMN search. At 51414, the UE (100) is camped on the PLMN B for disaster services.

FIG. 15 is a sequence signalling diagram illustrating a scenario of limit area of inbound disaster roamers to disaster area, according to the embodiments as disclosed herein.

Referring to the FIG. 15, consider a proposed method, describes the limit area of inbound disaster roamers to disaster Area (KI4). Followings are the steps in details—
1. Currently the granularity of controlling the disaster area is limited to tracking area.
2. However if the TA of disaster PLMN(PLMN D) and PLMN providing services to disaster inbound roamers(PLMN A) doesn't overlap exactly, there might be a situation when the UE (100) is latched to PLMN A although PLMN D is providing normal services in that area.
3. In order to avoid this problem, the UE (100) can send the location (for example in terms of geographical co-ordinates, GPS based location, the cell id or like so to the PLMN A in NAS or AS signalling and the PLMN A can validate the same with PLMN D before providing service to UE, optionally PLMN-A itself can validate if the UE (100) is in the correct location where disaster service have to be provided. This location information can be protected with a key provided by HPLMN or a MAC value is generated following integrity protection techniques so that PLMN-A is not able to alter any of the location information, HPLMN is very sure about the correct UE location.
4. This will reduce the granularity to cell level and the network will have better control over disaster Area.

In yet another embodiment, in 4GS (i.e. EPS) network, network should indicate to the UE (100) in NAS or AS message that it has faced disaster on 5GS and should not attempt to acquire service on 5GS. So that the UE (100) can save the battery without triggering the regular search of higher priority PLMN repeatedly.

Referring to the FIG. 15, at 51502, the RAN disaster occurs between the UE (100) and the PLMN D. At 51504, the UE (100) sends the registration request on the PLMN A. The UE (100) should include location co-ordinates/Cell Id. The PLMN A should validate UE location with PLMN D before providing service. At 51506, the UE (100) gets service if it is within disaster area.

The various actions, acts, blocks, steps, or the like in the flow charts (S400-S600, S1100 and S1200) may be performed in the order presented, in a different order or simultaneously. Further, in some embodiments, some of the actions, acts, blocks, steps, or the like may be omitted, added, modified, skipped, or the like without departing from the scope of the invention.

Accordingly, the embodiment herein is to provide a method performed by a user equipment in a wireless network. The method comprises receiving information related to disaster roaming from a first public land mobile network (PLMN) associated with the UE; detecting a disaster condition; determining whether a disaster roaming is disabled in the UE or the disaster roaming is enabled in the UE based on the information; and performing one of: enabling a disaster roaming service in the UE and allowing the UE to select a second PLMN for using the disaster roaming service during the disaster condition in response to determining that the disaster roaming is enabled in the UE, and disabling the disaster roaming service in the UE, in response to determining that the disaster roaming is disabled in the UE.

In an embodiment, wherein determining that the disaster roaming is disabled in the UE comprises: determining that the disaster roaming is disabled in the UE based on one of: the UE being not configured with the information, or the UE being configured with the information, wherein the information indicates that the disaster roaming is disabled in the UE.

In an embodiment, wherein determining that the disaster roaming is enabled in the UE comprises determining that the disaster roaming is enabled in the UE based on the UE being configured with the information, wherein the information indicates that the disaster roaming is enabled in the UE.

In an embodiment, the method further comprising: storing the information in a universal subscriber identity module (USIM) of the UE or in a mobile equipment (ME) of the UE.

In an embodiment, wherein selecting the PLMN to receive the disaster roaming service comprises selecting a forbidden PLMN (FPLMN) and registering with the FPLMN.

In an embodiment, wherein detecting the disaster condition comprises: detecting whether the disaster roaming service from an allowable PLMN is available in the wireless network to receive normal services; and detecting the disaster condition in case that the service from the allowable PLMN is not available in the wireless network to receive the normal services and at least one forbidden PLMN (FPLMN) indicates that the disaster roaming service is provided.

In an embodiment, wherein the first PLMN is one of a home PLMN (HPLMN) or an equivalent HPLMN (EHPLMN), and wherein the second PLMN is a forbidden PLMN (FPLMN).

In an embodiment, wherein the information is pre-configured in the UE.

Accordingly, the embodiment herein is to provide a UE in a wireless network. The UE comprises: a memory; a processor; and a disaster roaming service controller, connected to the memory and the processor, configured to: receive information related to disaster roaming from a first public land mobile network (PLMN) associated with the UE, detect a disaster condition, determine whether a disaster roaming is disabled in the UE or the disaster roaming is enabled in the UE based on the information, and perform one of: enabling a disaster roaming service in the UE and allowing the UE to select a second PLMN for using the disaster roaming service during the disaster condition in response to determining that the disaster roaming is enabled in the UE, and disable the disaster roaming service in the UE, in response to determining that the disaster roaming is disabled in the UE.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method of a user equipment (UE) in a wireless network, the method comprising:
receiving an indication of whether disaster roaming is enabled in the UE from a first public land mobile network (PLMN) associated with the UE;
detecting a disaster condition;
determining whether the disaster roaming is enabled in the UE based on the indication; and
enabling a disaster roaming service and selecting a second PLMN for using the disaster roaming service during the disaster condition, in response to determining that the disaster roaming is enabled in the UE.

17. The method of claim 16, further comprising disabling the disaster roaming service, in response to determining that the disaster roaming is disabled in the LE.

18. The method of claim 16, wherein determining that the disaster roaming is disabled in the LE comprises determining that the disaster roaming is disabled in the UE based on the indication being set to that the disaster roaming is disabled in the UE.

19. The method of claim 16, wherein determining that the disaster roaming is enabled in the UE comprises determining that the disaster roaming is enabled in the UE based on the indication being set to that the disaster roaming is enabled in the UE.

20. The method of claim 16, further comprising storing the indication in a universal subscriber identity module (USIM) of the UE or in a mobile equipment (ME) of the UE.

21. The method of claim 16, wherein selecting the second RAIN to use the disaster roaming service comprises selecting a forbidden PLMN (FPLMN) and registering with the FPLMN.

22. The method of claim 16, wherein detecting the disaster condition comprises:
detecting whether the disaster roaming service from an allowable PLAIN is available in the wireless network to receive normal services; and
detecting the disaster condition in case that the service from the allowable PLMN is not available in the wireless network to receive the normal services and at least one forbidden PLMN (FPLMN) indicates that the disaster roaming service is provided.

23. The method of claim 16, wherein the first PLMN comprises a home PLAN (HPLMN), and
wherein the second PLMN comprises a forbidden PLMN (FPLMN).

24. The method of claim 16, wherein the indication is pre-configured in the UE.

25. A user equipment (UE) in a wireless network, wherein the UE comprises:
a memory;
a processor; and
a disaster roaming service controller, connected to the memory and the processor, configured to:
receive an indication of whether disaster roaming is enabled in the LT from a first public land mobile network (PLMN) associated with the UE,
detect a disaster condition,
determine whether the disaster roaming is enabled in the LT based on the indication, and
enable a disaster roaming service and select a second PLMN for using the disaster roaming service during the disaster condition, in response to determining that the disaster roaming is enabled in the UE.

26. The UE of claim 25, wherein the disaster roaming service controller is further configured to disable the disaster roaming service, in response to determining that the disaster roaming is disabled in the LE.

27. The UE of claim 25, wherein the disaster roaming service controller is further configured to determine that the disaster roaming is disabled in the UE based on the indication being set to that the disaster roaming is disabled in the UE.

28. The UE of claim 25, wherein the disaster roaming service controller is further configured to determine that the disaster roaming is enabled in the UE based on the indication being set to that the disaster roaming is enabled in the UE.

29. The UE of claim 25, wherein the disaster roaming service controller is further configured to store the indication in a universal subscriber identity module (USIM) of the UE or in a mobile equipment (ME) of the UE.

30. The UE of claim 25, wherein the disaster roaming service controller is further configured to select a forbidden PLMN (FPLMN) and registering with the FPLMN.

31. The UE of claim 25, wherein the disaster roaming service controller is further configured to:
detect whether the disaster roaming service from an allowable PLMN is available in the wireless network to receive normal services, and
detect the disaster condition in case that the service from the allowable PLMN is not available in the wireless network to receive the normal services and at least one forbidden PLMN (FPLMN) indicates that the disaster roaming service is provided.

32. The UE of claim 25, wherein the first PLMN comprises a home PLMN (FPLMN), and
wherein the second PLMN comprises a forbidden PLMN (FPLMN).

33. The UE of claim 25, wherein the indication is pre-configured in the UE.
